(19) United States
(12) Patent Application Publication
(10) Pub. No.: US 2012/0328261 A1
(43) Pub. Date: Dec. 27, 2012

(54) VIDEO DISPLAY APPARATUS

(75) Inventor: Junichi MATSUNAGA, Daito-shi (JP)

(73) Assignee: FUNAI ELECTRIC CO., LTD., Osaka (JP)

(21) Appl. No.: 13/525,570

(22) Filed: Jun. 18, 2012

(30) Foreign Application Priority Data
Jun. 21, 2011 (JP) 2011-137823

(51) Int. Cl. H04N 5/775

(52) U.S. Cl. 386/230; 386/E05.07

(57) ABSTRACT

A video display apparatus is configured such that when a user returns a video signal input source device to a video reproduction device after switching an input source device from the video reproduction device to another device, viewing of the video from the video reproduction device can be started again right away from a previous viewing position. When the user switches the video signal input source device from a BD player to another device, a <user control pressed> play command to start the reproduction of video is sent to the BD player, after which, without waiting for receipt of a response from the BD player to this command, a <user control pressed> stop command is sent to the BD player. Consequently, even a BD player which continues to reproduce video signals even after receiving the <active source> command can be placed in a resume stop state.

### BACKGROUND OF THE INVENTION

1. Field of the Invention

The present invention relates to a video display apparatus such as a television receiver that is connectable to a video reproduction device and is capable of displaying video on the basis of a video signal received from the video reproduction device.

2. Description of the Related Art

Many AV (audio/visual) devices on the market today are devices having an HDMI (high definition multimedia interface) terminal, which are referred to as HDMI connectable devices. Many of these HDMI connectable AV devices have a linking function between devices, which use an HDMI-CEC (high definition multimedia interface—consumer electronics control) called “such-and-such link.” “HDMI-CEC” here is a standard for a function which controls, from an AV device such as a television receiver (hereinafter referred to as “TV receiver”) or a BD (Blu-ray Disc(trademark)) player, another AV device connectable by HDMI cable.

However, the HDMI-CEC standard is not a strict standard, and as long as the minimum functional requirements are met, the specifications for other functions or operations may be set freely by each manufacturer, so when a given CEC command is received from another AV device, the operation that is carried out often varies with each type of AV device produced by different manufacturers.

A typical command among CEC commands is a command called <active source>. This command is an input source notification command for notifying another HDMI-connectable device that the sending device itself has become the video signal input source device (has become the active device), and is used by the video signal input source device to notify another HDMI-connectable device that the TV receiver or other such video display device is currently outputting audio and video on the basis of audio and video signals that are input from a certain externally connectable device.

For example, as shown in FIG. 3A, when a TV receiver 101 displays video based on a video signal that is input from its own tuner, if the user presses the play key 151 on a remote control 141 for an HDMI-connectable BD player 102, the BD player 102 broadcasts an <active source> command to all of the devices connectable by HDMI (just the TV receiver 101 in the example of FIG. 3A). Then, the TV receiver 101 switches the video signal input source device from its own tuner to the BD player 102 that is connectable to the HDMI 1 terminal (the first HDMI terminal) on the TV receiver 101 in order to display video based on the video signal from the BD player 102, which has become the active device.

In a state in which the video signal input source device is the BD player 102 (when the TV receiver 101 is displaying video on the basis of a video signal received from the BD player 102), if the user operates the input switch key 129 on a remote control 121 and switches the video signal input source device once again to the tuner of the TV receiver 101 as shown in FIG. 3B, then the TV receiver 101 sends (broadcasts) an <active source> command to all of the externally connectable devices including the BD player 102 such that the TV receiver 101 itself will become the active device. The only thing defined by the HDMI-CEC standard is that the externally connectable device that has received the <active source> command (such as the BD player 102 that has received the <active source> command sent from the TV receiver 101) must confirm that this device itself is no longer in an active state. Therefore, when the <active source> command is received from the TV receiver 101 as shown in FIG. 3B, a certain model of the BD player 102 continues reproducing the video signal recorded to a recording medium (Blu-ray disc), another model of the BD player 102 enters a paused state, and yet another model of the BD player 102 actuates a resume stop function and stops reproduction after recording data that indicates the reproduction stop position (entering a resume stop state) just as if the stop key were pressed.

As was described above, the operation when the <active source> command is received from another externally connectable device (such as the TV receiver 101) varies with the model or type of the BD player 102 (video reproduction device), so for the BD player 102 which continues reproducing a video signal recorded to a recording medium even after receiving the <active source> command (one that does not stop or pause the reproduction of a video signal), unless the user manually stops or pauses the reproduction of a video signal by the BD player 102 prior to switching the video signal input source device to the tuner of the TV receiver 101, when video is again displayed on the TV receiver 101 based on the video signal that is input from the BD player 102 (reproduced by the BD player 102), it will be difficult to start viewing the video again right away, without rewinding, from the position at which the viewing was stopped previously (the reproduction stopping position from the previous time). This problem can also occur when the TV receiver 101 and the BD player 102 receive the <active source> command from an externally connectable device other than the TV receiver 101 while the TV receiver 101 is displaying video on the basis of a video signal received from the BD player 102.

To counter this, there is a known video reproduction and display system including a video display device and a video reproduction device, with which when the video input is switched, the video display device sends the video reproduction device a command requesting transmission of information about a state notification indicating the reproduction state of the video reproduction device, and when a controller of the video display device determines the video reproduction device state and input switching to be that of “the HDMI-connectable video reproduction device has been unselected during reproduction,” the video display device sends the video reproduction device an “activate command to stop or pause” (see Japanese Patent Application Laid-Open Publication No. 2010-21880). With this video reproduction and display system, there is no need for the user to stop or pause reproduction of a video signal manually even with a player that continues reproduction of a video signal recorded to a recording medium even after the video signal input source device to the video display device has been switched from this device itself (the video reproduction device) to another device.

However, with the video reproduction and display system represented in Japanese Patent Application Laid-Open Publication No. 2010-21880, the video display device sends the video reproduction device a command requesting transmission of information about a state notification of the video reproduction device, and a stop or pause command is sent to the video reproduction device after the response to this request for information about state notification has been received, so it ends up taking a long time until the video reproduction device is stopped or paused. Therefore, there ends up being a large discrepancy between the position where the user stopped viewing the last time (the reproduction position at the point when the video signal input source device was switched to another device) and the actual reproduction stopping position in the video reproduction device. Furthermore, with the video reproduction and display system represented in Japanese Patent Application Laid-Open Publication No. 2010-21880, deck control commands or vendor commands that are non-standard (there are few models compatible with the command) are used for stop or pause commands, reproduction start commands, and commands requesting the transmission of information about state notification. Therefore, if a video reproduction device and a video display device are devices made by different manufacturers, the video display device is often unable to perform the above-described control over the video reproduction device.

### SUMMARY OF THE INVENTION

In view of the above-described problems, preferred embodiments of the present invention provide a video display apparatus configured such that when a video signal input source device is switched during the display of video based on a video signal received from a video reproduction device, the video reproduction device can be automatically placed in a resume stop state, and when a user once again switches the input source device to the video reproduction device, viewing of the video can be started again right away from the previous viewing position.

According to a preferred embodiment of the present invention, a video display apparatus connectable to externally connectable devices including a video reproduction device includes a communication device that receives video signals from the externally connectable devices including a video reproduction device and sends and receives commands to and from the externally connectable devices, a display device that displays video based on video signals received by the communication device, and a video reproduction device stop controller arranged and programmed to perform a control process such that when video based on a video signal received by the communication device from the video reproduction device is displayed on the display device, if an input source notification command that provides notification that an externally connectable device other than the video reproduction device has become the video signal input source device is received by the communication device, or if an input source notification command that provides notification that the video display apparatus has become the video signal input source device is sent by the communication device to the video reproduction device, then a reproduction command that starts the reproduction of video is sent by the communication device to the video reproduction device, after which a stop command that stops reproduction after recording data indicating the reproduction stopping position is sent by the communication device to the video reproduction device without waiting for receipt of a response from the video reproduction device to the reproduction command.

The video display apparatus also preferably includes a high definition multimedia interface that is connectable to the externally connectable devices including the video reproduction device.

It is preferable that the input source notification command is an <active source> command, which is a type of CEC (consumer electronics control) command, the reproduction command is a <user control pressed> play command, which is a type of CEC command, and the stop command is a <user control pressed> stop command, which is a type of CEC command.

According to a preferred embodiment of the present invention, control is performed such that when video based on a video signal received from the video reproduction device is being displayed on the display device, if the user has switched the video signal input source device such that the video display apparatus has received an input source notification command from an externally connectable device other than the video reproduction device or such that the video display apparatus itself has sent an input source notification command to the video reproduction device, then a reproduction command that starts the reproduction of video is sent to the video reproduction device, after which a stop command that stops reproduction after recording data indicating the reproduction stopping position is sent to the video reproduction device without waiting for receipt of a response from the video reproduction device to the reproduction command.

The result of the above-described control is that, with a video reproduction device that continues reproducing a video signal even after receiving an input source notification command (such as an <active source> command), when a reproduction command is received from the video display apparatus, this command is ignored and reproduction is continued, and when a stop command is received from the video display apparatus, reproduction is stopped after recording data indicating the reproduction stopping position (a resume stop state is entered). Moreover, with a video reproduction device that stops or pauses the reproduction of a video signal upon receiving an input source notification command, when a reproduction command is received from the video display apparatus, reproduction is started, and when a stop command is received from the video display apparatus, reproduction is stopped after recording data indicating the reproduction stopping position (a resume stop state is entered). Here, the reason that the video display apparatus sends the stop command after first sending the reproduction command to the video reproduction device is that with a video reproduction device that stops the reproduction of a video signal upon receiving an input source notification command, the resume stop state has already been entered at a point when an input source notification command is received, and if a stop command is sent to the video reproduction device that is in a resume stop state, the video reproduction device will end up entering a complete stop state (a state in which data indicating the reproduction stopping position has not been stored, and when a reproduction command is received, reproduction starts from the front of the video data recorded to the recording medium), rather than a resume stop state.

As described above, with a preferred embodiment of the present invention, when video based on a video signal received from the video reproduction device is being displayed, if the video signal input source device is switched, the video reproduction device can automatically enter a resume stop state, so when the user again switches the input source device to the video reproduction device, reproduction of the video signal by the video reproduction device can be restarted at the previous reproduction stopping position indicated by the data recorded on the video reproduction device side. Consequently, the user can resume viewing the video from the previously viewed position right away without searching for the previous reproduction stopping position.

In addition, with the video display apparatus according to a preferred embodiment of the present invention, because a stop command is sent to the video reproduction device without waiting for receipt of a response from the video reproduction device to the reproduction command, the discrepancy between the position where the user ended viewing the last time and the actual reproduction stopping position in the video reproduction device can be reduced as compared to a case in which a command is sent to the video reproduction device requesting the transmission of information about state notification, and a stop or pause command is sent to the video reproduction device after receiving a response to this command (information about state notification), as described in Japanese Patent Application Laid-Open Publication No. 2010-21880.

The advantageous effects described above can be obtained reliably if the video display apparatus is HDMI-connectable with externally connectable devices including a video reproduction device.

The <active source> command, the <user control pressed> play command, and the <user control pressed> stop command, which are typical CEC commands, preferably are used respectively as the input source notification command, the reproduction command, and the stop command. As a result, unlike when using a deck control command or vendor command as with the video reproduction and display system of Japanese Patent Application Laid-Open Publication No. 2010-21880, the above-described advantageous effects can be obtained even if the video reproduction device and the video display apparatus are made by different manufacturers.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an electrical block configuration diagram of an AV system including a TV receiver according to a preferred embodiment of the present invention.

FIG. 2 is a flowchart of stop control processing for a BD player in a TV receiver according to a preferred embodiment of the present invention.

FIG. 3A is an explanatory diagram of the processing performed by a conventional TV receiver and a BD player when a video signal input source is switched from a tuner of the TV receiver to the BD player, and FIG. 3B is a diagram of the processing performed by the conventional TV receiver and the BD player when the video signal input source is switched once again from the BD player to the tuner of the TV receiver.

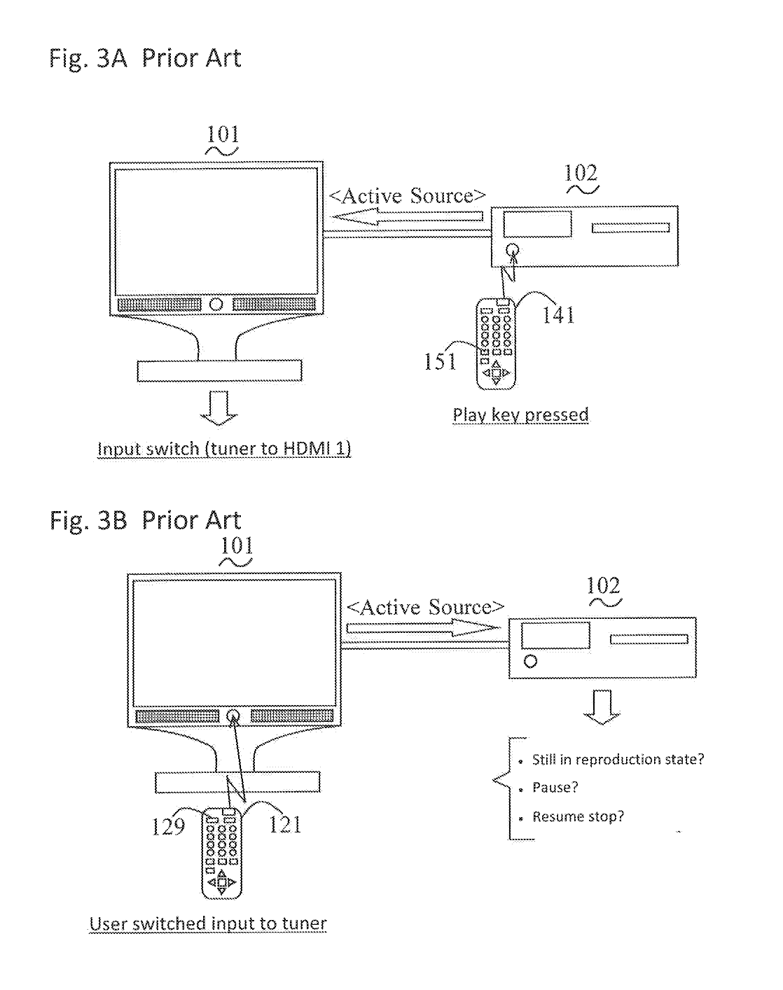

### DETAILED DESCRIPTION OF THE PREFERRED EMBODIMENTS

Preferred embodiments of the present invention will be described below with reference to the drawings. In the following preferred embodiments, a case in which the present invention is applied to a liquid crystal digital television receiver will be described as a non-limiting example. Note that the preferred embodiments described below are not intended to encompass everything about the present invention, and the present invention is not limited to just the following preferred embodiments.

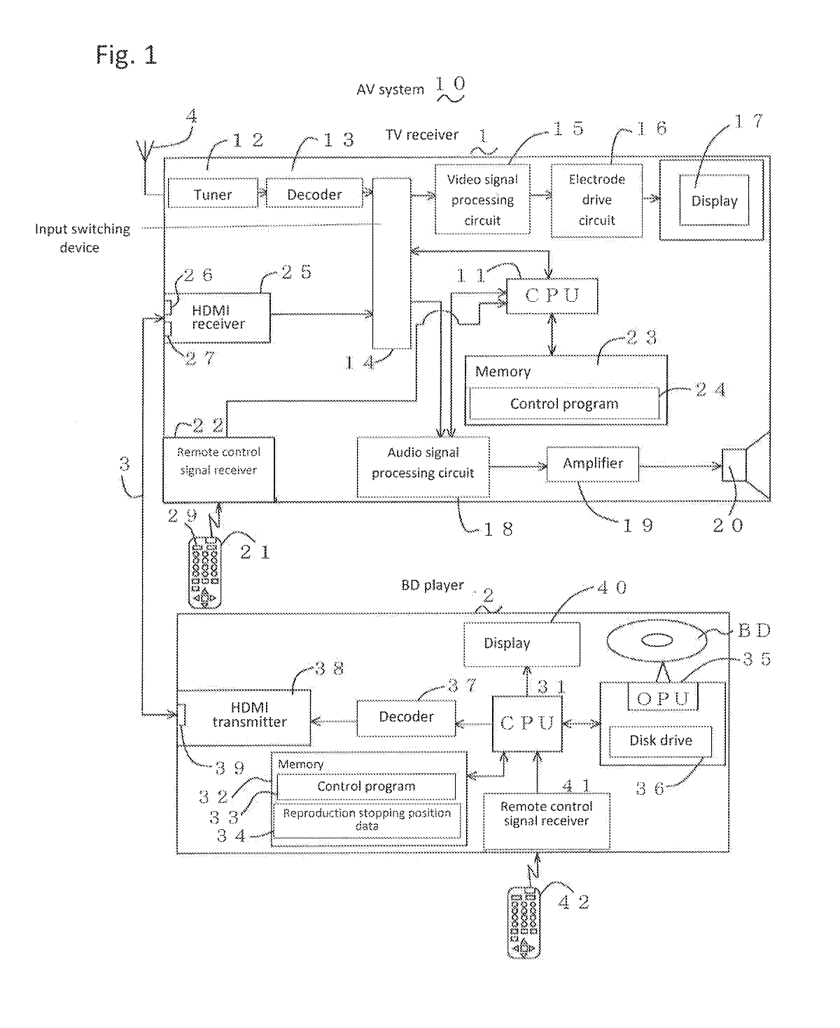

FIG. 1 shows an AV (audio/visual) system preferably including a liquid crystal digital television receiver, which is a video display apparatus according to the present preferred embodiment (hereinafter referred to as a TV receiver). The AV system 10 preferably includes a TV receiver 1 and a BD (Blu-ray disc(trademark)) player 2 (video reproduction device). The TV receiver 1 and the BD player 2 are connectable by an HDMI (high definition multimedia interface) cable 3.

As shown in FIG. 1, the TV receiver 1 includes a CPU (video reproduction device stop controller) that controls the entire device. Furthermore, the TV receiver 1 includes a tuner that receives a digital television broadcast signal (transport stream) via an antenna 4, and an (MPEG) decoder 13 that produces video streams, audio streams, and data streams, for example, by decoding packets in the transport stream received by the tuner 12.

Moreover, the TV receiver 1 includes an input switching device 14 that switches the input source device of audio and video signals by selectively outputting the audio and video signals included in an HDMI signal received by an HDMI receiver 25 or audio and video streams produced by the decoder 13 to a video signal processing circuit 15 and an audio signal processing circuit 18. The input switching device 14 receives, from a remote control signal receiver 22 via the CPU 11, a control signal corresponding to the content of the switching operation performed by the user using a remote control 21 and switches the video signal input source device corresponding to the received control signal content.

In addition, the TV receiver 1 includes the video signal processing circuit 15 that performs various kinds of processing such as image processing on the video signals that are output from the input switching device 14 and reproduces the processed video signals, an electrode drive circuit 16 that drives display electrodes on the basis of the video signals received from the video signal processing circuit 15, and a liquid crystal display panel 17 (display device) which displays video based on the video signals that have undergone signal processing by the video signal processing circuit 15.

Furthermore, the TV receiver 1 includes the audio signal processing circuit 18 that performs various kinds of audio signal processing including D/A conversion processing on the audio signals that are input via the input switching device 14, an amplifier 19 that amplifies the audio signals that are output from the audio signal processing circuit 18, and a built-in main speaker 20 that outputs audio by being driven by the audio signals (drive signals) amplified by the amplifier 19.

The TV receiver 1 includes the remote control 21 that sends out a remote control signal corresponding to the instructive operation from the user, and the remote control signal receiver 22 that receives remote control signals from the remote control 21 is provided preferably on the main body side of the TV receiver 1. The remote control 21 is provided with an input switching key 29 which is an instructive operation key used to switch the video signal input source device. Moreover, the TV receiver 1 includes a memory 23 that stores various kinds of data including a control program 24.

In addition, the TV receiver 1 includes the HDMI receiver 25 (communication device) that receives HDMI signals (including video signals and audio signals) that are output from an externally connectable device such as the BD player 2 and that sends and receives CEC (consumer electronics control) commands (including responses) to and from the externally connectable device such as the BD player 2. The HDMI receiver 25 preferably includes two terminals to connect external devices (an HDMI 1 terminal 26 and an HDMI 2 terminal 27), and the BD player 2 is connectable to the HDMI 1 terminal 26, which is the first terminal.

The BD player 2 includes a CPU 31 that controls the entire device and a memory 32 that stores a control program 33 and various kinds of data including reproduction stopping position data 34, which is data indicating the reproduction stopping position at the point when reproduction was stopped the last time. Furthermore, the BD player 2 includes an optical pickup unit (hereinafter referred to as “OPU”) 35 that takes the reflected light obtained by directing light at the BD and converts it as reading light into an electrical signal and a disk drive 36 that reads the data recorded to the BD by driving the OPU 35 and the BD.

Moreover, the BD player 2 includes a decoder 37 that decodes video, audio, or other such data read out by the disk drive 36 and produces a video signal (digital video signal) and an audio signal (digital audio signal) and an HDMI transmitter 38 that is an interface circuit that sends video signals, audio signals, and CEC commands (including responses) by communication that conforms to the HDMI standard. The HDMI transmitter 38 is provided with an HDMI terminal 39 that is a terminal used to connect an external device, and the TV receiver 1 is connectable to the HDMI terminal 39.

In addition, the BD player 2 includes a display 40 that displays various kinds of messages, information or the like and a remote control 42 that sends remote control signals corresponding to the instructive operation from the user. A remote control signal receiver 41 that receives remote control signals from the remote control 42 is provided preferably on the main body side of the BD player 2, for example.

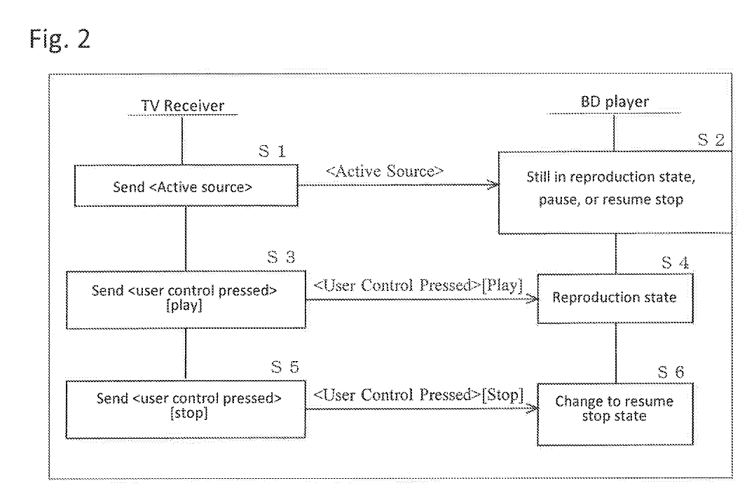

Next, referring to the flowchart in FIG. 2, a description will be given regarding the stop control processing performed by the TV receiver 1 on the BD player 2 when the user switches the video signal input source device from the BD player to another device (another externally connectable device or the tuner 12 of the TV receiver 1 itself) on the TV receiver 1. For example, when the user operates the input switching key 29 on the remote control 21 to switch the video signal input source device from the BD player 2 to the tuner 12 of the TV receiver 1 itself, the CPU 11 of the TV receiver 1 sends (broadcasts) an <active source> command, which is a type of CEC command, to the BD player 2 such that the BD player 2 will become the active device (to notify that this device has become the active device), on the basis of the control program 24 (S1). When the <active source> command is received, some models of BD player 2 will continue reproducing the video signal recorded to the recording medium (the Blu-ray disc(trademark)), while other models of BD player 2 will enter a pause state, and yet other models of BD player 2 will actuate the resume stop function just as if the stop key were pressed, stopping the reproduction after storing the reproduction stopping position data 34 in the memory 32 (entering a resume stop state) (S2).

Next, the CPU 11 of the TV receiver 1 sends a <user control pressed> play command, which is a CEC command to start the reproduction of video (hereinafter abbreviated as a play command and referred to as a reproduction command in the claims), to the BD player 2 via the HDMI receiver 25 (S3), after which the CPU 11 sends, without waiting for receipt of a response from the BD player 2 to this command, a <user control pressed> stop command, which is a CEC command to stop reproduction after storing data indicating the reproduction stopping position (the reproduction stopping position data 34) (hereinafter abbreviated as a stop command), to the BD player 2 via the HDMI receiver 25 (S5). Note that the <user control pressed> command is a command to send the content of a remote control key, and when the <user control pressed> play command is sent from the TV receiver 1, for instance, the BD player 2 performs the same operation as when the play key of the BD player 2 has been pressed, via either the main unit operation portion or the remote control 42.

As a result of the aforementioned control process being performed, with a BD player 2 that continues to reproduce video signals even after receiving the <active source> command, when a play command is received from the TV receiver 1, this is ignored, and the BD player 2 continues to play (S4), and when a stop command is received from the TV receiver 1, reproduction is stopped after storing the reproduction stopping position data 34 in the memory 32 (a resume stop state is entered) (S6). Furthermore, with a BD player 2 that stops or pauses the reproduction of a video signal when the <active source> command is received, reproduction is started when a play command is received from the TV receiver 1 (S4), and when a stop command is received from the TV receiver 1, reproduction is stopped after storing the reproduction stopping position data 34 in the memory 32 (a resume stop state is entered) (S6).

Here, the reason that the TV receiver 1 sends the stop command after first sending the play command to the BD player 2 is that with a BD player 2 that stops the reproduction of a video signal upon receiving the <active source> command, the resume stop state has already been entered at a point when the <active source> command is received, and if a stop command is additionally sent to the BD player 2 that is in a resume stop state, the BD player 2 will end up entering a complete stop state (a state in which the reproduction stopping position data 34 has not been stored in the memory 32, and when a play command is received, reproduction starts from the front of the video data recorded to the BD), rather than a resume stop state.

In the above description, a case in which the user has switched the video signal input source device of the TV receiver 1 from the BD player 2 to the tuner 12 of the TV receiver 1 was described as an example, but in a case in which the user has switched the video signal input source device of the TV receiver 1 from the BD player 2 to an externally connectable device other than the TV receiver 1, the only difference is that in the aforementioned step S1, the device that sends the <active source> command is not the TV receiver 1 or the tuner 12 of the TV receiver 1, but rather an externally connectable device that becomes a new input source device, and the processing performed in steps S2 to S6 remains the same as that described above with reference to FIG. 2.

As was described above, with the TV receiver 1 of the present preferred embodiment, when video is being displayed on the basis of a video signal received from the BD player 2, if the input source device of this video signal is switched, the BD player 2 can be placed in a resume stop state automatically, so when the user switches the input source device once again to the BD player 2, the reproduction of the video signal by the BD player 2 can be restarted from the reproduction stopping position of the previous time indicated by the reproduction stopping position data 34 recorded to the memory 32 on the side of the BD player 2. Consequently, the user can resume viewing the video from the BD player 2 from the previously viewed position right away (without searching for the previous reproduction stopping position).

Moreover, the TV receiver 1 is preferably configured such that the stop command is sent to the BD player 2 without waiting for receipt of a response from the BD player 2 to the <active source> command and the play command, so the discrepancy between the position where the user ended viewing the last time and the actual reproduction stopping position in the BD player 2 can be reduced as compared to a case in which a command is sent to the BD player 2 requesting the transmission of information about state notification, and a stop or pause command is sent to the BD player 2 after receiving a response to this command (information about state notification), as described in Japanese Patent Application Laid-Open Publication No. 2010-21880.

In addition, with the TV receiver 1, the <active source> command, the <user control pressed> play command, and the <user control pressed> stop command, which are typical CEC commands, preferably are used respectively as the input source notification command, the reproduction command, and the stop command as recited in the claims, and as a result, unlike when using a deck control command or vendor command as with the video reproduction and display system presented in Japanese Patent Application Laid-Open Publication No. 2010-21880, the aforementioned advantageous effects can be obtained even if the video reproduction device and the video display apparatus are made by different manufacturers.

Note that the present invention is not limited to the constitution of the aforementioned preferred embodiments, and various modifications are possible without departing from the gist of the present invention. For example, in the aforementioned preferred embodiments, an example was shown in which the video display apparatus was a TV receiver including a tuner, but the video display apparatus may instead be a display (liquid crystal display or plasma display) having no tuner. Furthermore, the video reproduction device is not limited to being a BD player, and may instead be a BD recorder, a DVD recorder, a DVD player, or the like. Moreover, in the aforementioned preferred embodiments, an example was shown in which the AV system included a TV receiver and a BD player, but the AV system may have a configuration that includes two or more video reproduction devices in addition to a TV receiver or other such video display apparatus.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A video display apparatus connectable to externally connectable devices including a video reproduction device, the video display apparatus comprising:
a communication device that receives video signals from the externally connectable devices including the video reproduction device and sends and receives commands to and from the externally connectable devices;
a display device that displays video based on a video signal received by the communication device; and
a video reproduction device stop controller arranged and programmed to perform a control process such that when video based on the video signal received by the communication device from the video reproduction device is displayed on the display device, if an input source notification command that provides notification that one of the externally connectable devices other than the video reproduction device has become the video signal input source device is received by the communication device, or if an input source notification command that provides notification that the video display apparatus has become the video signal input source device is sent by the communication device to the video reproduction device, then a reproduction command that starts reproduction of video is sent by the communication device to the video reproduction device, after which a stop command that stops reproduction after recording data indicating a reproduction stopping position is sent by the communication device to the video reproduction device without waiting for receipt of a response from the video reproduction device to the reproduction command.

2. The video display apparatus according to claim 1, further comprising a high definition multimedia interface that is connectable to the externally connectable devices including the video reproduction device.

3. The video display apparatus according to claim 2, wherein the input source notification command is an <active source> command, which is a consumer electronics control command;
the reproduction command is a <user control pressed> play command, which is a consumer electronics control command; and
the stop command is a <user control pressed> stop command, which is a consumer electronics control command.
